(19) United States
(12) Patent Application Publication
(10) Pub. No.: US 2007/0133106 A1
(43) Pub. Date: Jun. 14, 2007

(54) Optical system and method for fabricating the same

(75) Inventor: Seong-Ha Park, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/637,981

(22) Filed: Dec. 13, 2006

(30) Foreign Application Priority Data
Dec. 14, 2005 (KR) 123477/2005

(51) Int. Cl. G02B 9/00

(52) U.S. Cl. 359/738

(57) ABSTRACT

An optical system includes at least one lens, and a barrel in which the lenses are mounted, the barrel having, at one end, a stair-shaped opening perpendicular to an optical axis so as to enable light to be incident into the optical system, the opening having at least two stepped layers.

### CLAIM OF PRIORITY

This application claims priority to an application entitled “Optical System and Method for Fabricating the Same,” filed in the Korean Intellectual Property Office on Dec. 14, 2005 and assigned Serial No. 2005-123477, the contents of which are incorporated herein by reference.

### BACKGROUND OF THE INVENTION

1. Field of the Invention

The present invention relates to an optical system, and more particularly to an optical system having a barrel with at least one lens thereto.

2. Description of the Related Art

Nowadays, with the development of the robot industry and the development and spread of various types of digital devices, optical systems that include lenses have been used in various ways that differ in comparison to the prior art. For example, digital devices often include a wireless communication terminal having a camera function. In the case of robots, many types of optical systems have been mounted on robots which providing a variety of functions, such as monitoring.

The optical system may include a plurality of lenses, and a barrel for fixing the lenses, restricting incident light, etc.

FIG. 1 is a sectional view of a conventional optical system. Referring to FIG. 1, the optical system 100 includes one or more lenses 121 to 124, irises 131, 132, 141, 142 for restricting unnecessary light, a barrel 110 in which the lenses 121 to 124 are mounted, and support members 151, 152. The irises 131, 132 are disposed between the lenses 123, 124, and the irises 141, 142 are disposed between the lenses 122, 123.

However, since off-axial rays, which are obliquely incident with respect to an optical axis, are irregularly reflected from the inner wall surface of the barrel, flare and ghosting may partially occur in displayed images.

### SUMMARY OF THE INVENTION

The present invention has been made to solve the above-mentioned problems occurring in the prior art, and, in one aspect, provides an optical system capable of preventing flare and ghosting from occurring.

There is accordingly provided an embodiment featuring an optical system that includes at least one lens, and a barrel in which the one or more lenses are mounted, the barrel having a stair-shaped opening which is formed at one end. The opening is perpendicular to the optical axis so as to enable light to be incident into the optical system, the opening having at least two stepped layers.

In the optical system, light incident along an off-axis is doubly blocked by means of the barrel.

In another aspect, there is provided a method for fabricating an optical system having a plurality of lenses, the method including the steps of: fabricating a hollow barrel for accommodating, within, the inserting and mounting of lenses, said barrel having an opening with stepped layers so formed as to make an angle that is, within a predetermined tolerance, disposed inside an angle of view of the lenses to be mounted; and arranging the lenses along an optical axis within the barrel to achieve said angle of view.

### BRIEF DESCRIPTION OF THE DRAWINGS

The above and other aspects, features and advantages of the present invention will be more apparent from the following detailed description taken in conjunction with the accompanying drawings, in which:

FIG. 1 is a sectional view of an optical system according to the prior art; and

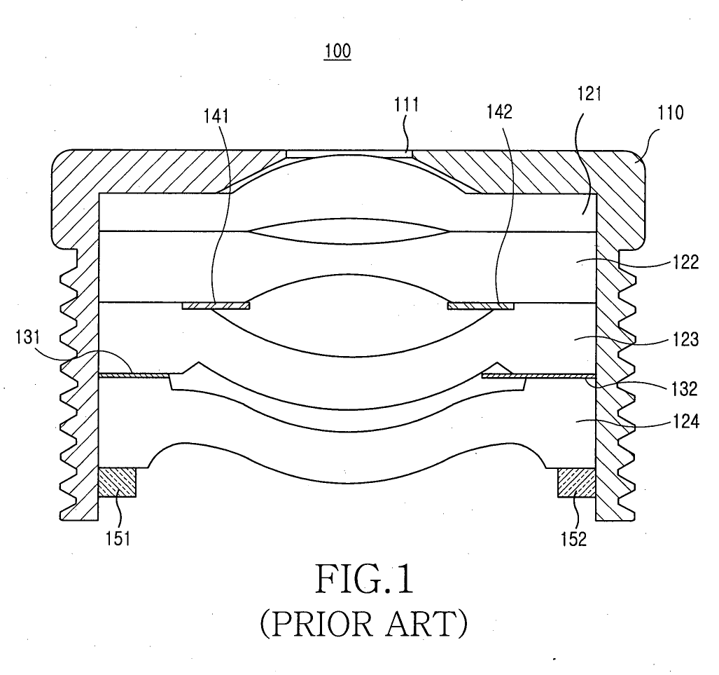

FIG. 2 is a sectional view of an optical system according to an embodiment of the present invention.

### DETAILED DESCRIPTION

In the discussion to follow, detailed description of known functions and configurations incorporated herein is omitted for conciseness and clarity of presentation.

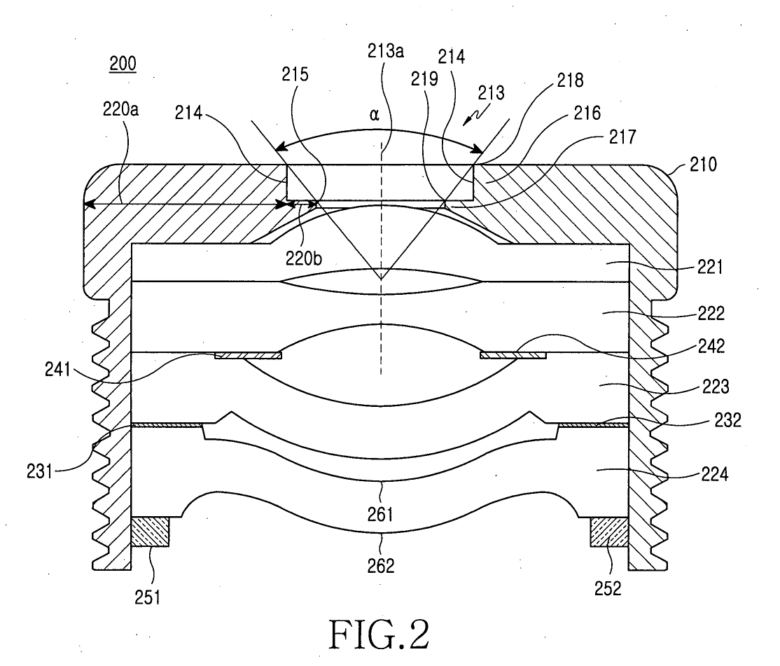

FIG. 2 is a sectional view showing, by way of illustrative and non-limitative example, an optical system 200 according to a preferred embodiment of the present invention. The optical system 200 includes a plurality of lenses 221 to 224, irises 231, 232, 241, 242, and a hollow barrel 210 into which the lenses 221 to 224 are mounted. As seen in FIG. 2 the irises 231, 232, 241, 242 are respectively inserted between adjacent ones of the lenses 222 to 224. The barrel 210 has, at one end, a stair-shaped opening 213 which is perpendicular to the optical axis 213a so as to enable light to be incident into the optical system 200. The stair-shaped opening 213 has at least two stepped layers 214, 215 configured for repeatedly blocking light incident at an off-axis, i.e., at angles less and more oblique than angle α. The layer 214 surrounds what FIG. 2 shows as a groove of first rectangular cross-section, and the layer 215 surrounds what is shown as a groove of second rectangular cross-section. The groove of first rectangular cross-section opens to an exterior of the barrel 210, and the groove of second rectangular cross-section opens into the groove of first rectangular cross-section.

The lenses 221 to 224 are inserted into the barrel 210, and arranged to form an image.

The angle α included by the stepped layers 214, 215 is formed within a tolerance of ±2° with respect to angle of view of the lenses 221 to 224 mounted in the barrel 210. More specifically, each stepped layer 214, 215 forms a corresponding step 216, 217 having an outer corner 218, 219. The angle α is defined by lines passing obliquely through the outer corners and collectively forming a cone. Each step 216, 217 has a top surface with a width 220a, 220b. The widths 220a, 220b become narrower from the outer side to the inner side of the optical system 200. In other words, the step 216 located on the outer side of the optical system 200 has a width 220a wider than that of the step 217 located on inner side of the optical system 200. The widths 220a, 220b are such that the outer step corners 218, 219 collectively define the angle α, which, within a predetermined tolerance, encompasses an angle of view of the lenses 221 to 224. Although merely two stepped layers 214, 215 are shown, the opening 213 may be configured with more than two stepped layers.

In FIG. 2 the angle of view is shown to coincide with the angle α.

More generally, however, the steps 216, 217 in the barrel 210 may have widths determined by an equation below.
angle of opening in barrel<angle of view±2° Equation

Advantageously, off-axial rays incident with angles other than the angle of view of the optical system 200, which may include stray and non-image rays, are blocked by the stepped layers 214, 215. It is accordingly possible to prevent flare and ghosting caused by the off-axial rays from occurring.

Moreover, the inner wall surface of the barrel 210 is preferably subjected to a special dull finishing, so that irregularly reflected light can be absorbed and thus internal reflection can be minimized.

Each of the irises 231, 232, 241, 242 has a thin film shape, and restricts off-axial rays, thereby more effectively preventing flare and ghosting from occurring. If the situation requires, an antireflection layer may be coated on a side surface 261, 262 of each of the lenses 221 to 224.

A method for fabricating an optical system 200 according to another embodiment of the present invention includes the step of fabricating the barrel 210 for accommodating, within, the inserting and mounting of lenses, said barrel having an opening 213 with a plurality of stepped layers 214, 215 so formed as to make an angle α smaller than the angle of view of the lenses 221 to 224, and a step of arranging the lenses along the optical axis 213a in the barrel.

According to the present invention as described above, an opening of a barrel is formed in a stair shape having two or more stepped layers, so that it is possible to efficiently prevent flare from occurring without adding separate apparatuses. Further, according to the present invention as described above, it is possible to prevent flare and ghost from occurring by means of the smaller number of irises, as compared with the prior art.

Although preferred embodiments of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. An optical system comprising:
a lens system that includes at least one lens; and
a barrel in which the at least one lens is mounted, the barrel having, at one end, a stair-shaped opening which is configured perpendicular to an optical axis of said at least one lens so as to enable light to be incident into the optical system, the opening having at least two stepped layers respectively disposed to make the opening stair-shaped.

2. The optical system as claimed in claim 1, wherein said at least one lens amounts to at least two lenses, said optical system further comprising at least one iris respectively inserted between adjacent ones of the at least two lenses in order to restrict unnecessary light.

3. The optical system as claimed in claim 1, wherein the stepped layers form respective steps having widths that become narrower from an outer side to an inner side of the optical system, to thereby define an angle disposed, to within a predetermined tolerance, inside an angle of view of the lens system.

4. The optical system as claimed in claim 1, wherein the stepped layers of the opening are formed so as to define an angle that is, within an error of ±1°, smaller than an angle of view of the lens system.

5. The optical system as claimed in claim 1, wherein one or more of said at least one lens has a side surface on which is coated an antireflection layer.

6. The optical system as claimed in claim 1, further comprising support members for supporting said at least one lens.

7. The optical system as claimed in claim 1, wherein the at least two layers amount to two layers disposed so that, collectively, the layers doubly block light incident along an axis offset from the optical axis.

8. A method for fabricating an optical system provided with a plurality of lenses, comprising:
fabricating a hollow barrel for accommodating, within, inserting and mounting of lenses, said barrel having an opening with a plurality of stepped layers so formed as to make an angle that is, within a predetermined tolerance, disposed inside an angle of view of the lenses to be mounted; and
arranging the lenses along an optical axis within the barrel to achieve said angle of view.

9. A lens barrel for an optical system, said barrel being hollow to accommodate at least one lens mounted inside the barrel, said barrel having, at one end, a first groove of rectangular cross-section that opens to an exterior of the barrel and, seated within the first groove, a second groove of rectangular cross-section, the second groove opening into the first groove, both grooves being longitudinally perpendicular to an optical axis of said at least one lens and collectively forming a stair-shaped opening to said barrel.

10. The lens barrel of claim 9, wherein stairs of said stair-shaped opening have outer corners, lines passing through said corners defining a cone, an angle of view of a lens from among said at least one lens coinciding with said cone to within a predetermined tolerance.

11. The lens barrel of claim 10, wherein the predetermined tolerance is ±1°.

12. The lens barrel of claim 10, wherein the predetermined tolerance is ±2°.

13. The lens barrel of claim 9, wherein stairs of said stair-shaped opening are each defined by a surrounding, respective layer, the layers being non-overlapping, and, for any two of the layers, the more interior of the two layers is narrower in width.

14. The optical system of claim 13, wherein the two layers are disposed so that, collectively, the layers doubly block light incident along an axis offset from the optical axis.

15. The lens barrel of claim 9, wherein, seated within the second groove, is disposed a third groove of rectangular cross-section, the third groove opening into the second groove and being longitudinally perpendicular to an optical axis of said at least one lens.

16. An optical system comprising the lens barrel of claim 9, and further comprising a lens system that includes said at least one lens.

17. The optical system of claim 16, wherein the lens system includes at least two lenses, said optical system further comprising at least one iris respectively inserted between adjacent ones of the at least two lenses in order to restrict unnecessary light.

18. The optical system of claim 16, wherein stairs of said stair-shaped opening have outer corners, lines passing through said corners defining a cone, an angle of view of a lens from among said at least one lens coinciding with said cone to within a predetermined tolerance.

19. The optical system of claim 16, wherein one or more of said at least one lens has a side surface on which is coated an antireflection layer.

20. The optical system of claim 16, further comprising support members for supporting said at least one lens.
